(19) United States
(12) Patent Application Publication
(10) Pub. No.: US 2025/0379727 A1
(43) Pub. Date: Dec. 11, 2025

(54) METHOD AND APPARATUS FOR FAST KEY SHARING BETWEEN USER DEVICES IN A WIRELESS COMMUNICATION SYSTEM

(71) Applicant: Samsung Electronics Co., Ltd., Suwon-si (KR)

(72) Inventors: Taewoo KIM, Suwon-si (KR); Jiin KIM, Suwon-si (KR); Jihye LEE, Suwon-si (KR)

(21) Appl. No.: 18/939,832

(22) Filed: Nov. 7, 2024

(30) Foreign Application Priority Data
Jun. 7, 2024 (KR) 10-2024-0074458

(51) Int. Cl. H04L 9/08

(52) U.S. Cl. CPC H04L 9/0838

(57) ABSTRACT

The present disclosure relates to a 5G communication system or a 6G communication system for supporting higher data rates beyond a 4G communication system, such as long term evolution (LTE). A method performed by a first device in a wireless communication system is provided. The method includes receiving, from a reader device, first information on whether the reader device supports a fast transaction and the reader device's access level, and identifying a method in which the reader device validates a second device, based on the first information, wherein the first device is an owner device validated by the reader device, and wherein the second device is a friend device not validated by the reader device.

### CROSS-REFERENCE TO RELATED APPLICATION(S)

This application is based on and claims priority under 35 U.S.C. § 119(a) of a Korean patent application number 10-2024-0074458, filed on Jun. 7, 2024, in the Korean Intellectual Property Office, the disclosure of which is incorporated by reference herein its entirety.

### BACKGROUND

### 1. Field

The disclosure relates to a method and an apparatus for sharing a terminal's encryption key with a friend terminal. More particularly, the disclosure relates to a method and an apparatus for sharing a terminal's encryption key with a friend terminal such that validation of the friend terminal by a reader device is simplified or omitted.

### 2. Description of Related Art

Considering the development of wireless communication from generation to generation, the technologies have been developed mainly for services targeting humans, such as voice calls, multimedia services, and data services. Following the commercialization of 5G (5th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive eXtended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

According to Aliro which is an open standard specification related to the Internet of things or matter, which is a standard specification related to smart home devices, reader devices (for example, door locks or entry/exit gates) define mobile access solutions such that users or user devices (for example, terminals or mobile devices) access the same. There has also been active discussion regarding a scheme for enabling users or user devices to access reader devices more quickly and conveniently. Accordingly, the disclosure discusses a scheme for enabling not only users or user devices, but also friend devices to access reader devices more conveniently.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for sharing a terminal's encryption key with a friend terminal.

another aspect of the disclosure is to provide a method and an apparatus for sharing a terminal's encryption key with a friend terminal such that validation of the friend terminal by a reader device is simplified or omitted.

Additional aspects will be set forth in part in the description which follows and, in part, will be apparent from the description, or may be learned by practice of the presented embodiments.

In accordance with an aspect of the disclosure, a method performed by a first device in a wireless communication system is provided. The method includes receiving, from a reader device, first information on whether the reader device supports a fast transaction and the reader device's access level, and identifying a method in which the reader device validates a second device, based on the first information, wherein the first device is an owner device validated by the reader device, and wherein the second device is a friend device not validated by the reader device.

In accordance with another aspect of the disclosure, a method performed by a reader device in a wireless communication system is provided. The method includes transmitting, to a first device, first information on whether the reader device supports a fast transaction and the reader device's access level, transmitting, to a second device, an authorization command, based on the first information, and receiving, from the second device, a response to the authorization command, wherein the response includes second information including a cryptogram and an identifier of a device, wherein a method in which the reader device validates the second device is based on the first information, wherein the first device is an owner device validated by the reader device, and wherein the second device is a friend device not validated by the reader device.

In accordance with another aspect of the disclosure, a first device in a wireless communication system is provided. The first device include a transceiver and at least one processor coupled to the transceiver, wherein the one processor is configured to receive, from a reader device, first information regarding whether the reader device supports a fast transaction and the reader device's access level, and identify a method in which the reader device validates a second device, based on the first information, wherein the first device is an owner device validated by the reader device, and wherein the second device is a friend device not validated by the reader device.

In accordance with another aspect of the disclosure, a reader device in a wireless communication system is provided. The reader device includes a transceiver and a processor coupled with the transceiver, wherein the reader device is configured to transmit, to a first device, first information regarding whether the reader device supports a fast transaction and the reader device's access level, transmit, to a second device, an authorization command, based on the first information, and receive, from the second device, a response to the authorization command, wherein the response includes second information including a cryptogram and an identifier of a device, wherein a method in which the reader device validates the second device is based on the first information, wherein the first device is an owner device validated by the reader device, and wherein the second device is a friend device not validated by the reader device.

A method and an apparatus according to various embodiments of the disclosure apply a fast transaction procedure not only to an owner user device, but also to a friend user device. Accordingly, the friend device quickly access a reader device which does not require a high level of security through the fast transaction. In addition, signaling overhead due to additional authorization is reduced.

In accordance with another aspect of the disclosure, one or more non-transitory computer-readable storage media storing computer-executable instructions that, when executed by one or more processors individually or collectively, cause a first device in a wireless communication system to perform operations are provided. The operations include receiving, from a reader device, first information on whether the reader device supports a fast transaction and the reader device's access level, and identifying a method in which the reader device validates a second device, based on the first information, wherein the first device is an owner device validated by the reader device, and wherein the second device is a friend device not validated by the reader device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a configuration of an Aliro network in a wireless communication system according to an embodiment of the disclosure;

FIG. 2 illustrates a configuration of a reader device in a wireless communication system according to an embodiment of the disclosure;

FIG. 3 illustrates a configuration of a user device in a wireless communication system according to an embodiment of the disclosure;

FIG. 4 illustrates a configuration of a network configured such that a friend terminal accesses a reader device in a wireless communication system according to an embodiment of the disclosure;

FIG. 5 illustrates signal flows during a transaction between a terminal and a reader device according to an embodiment of the disclosure;

FIG. 6 illustrates signal flows during a transaction between a friend terminal and a reader device according to an embodiment of the disclosure;

FIG. 7 illustrates signal flows during a transaction between a friend terminal and a reader device according to an embodiment of the disclosure;

FIG. 8 illustrates classification of key sharing types according to a fast transaction and an access level according to an embodiment of the disclosure;

FIG. 9 illustrates a method for transferring information regarding whether a reader device supports a fast transaction and regarding the reader device's access level according to an embodiment of the disclosure;

FIG. 10 illustrates a method for transferring information regarding whether a reader device supports a fast transaction and regarding the reader device's access level according to an embodiment of the disclosure;

FIG. 11 illustrates a method for transferring information regarding whether a reader device supports a fast transaction and regarding the reader device's access level according to an embodiment of the disclosure;

FIG. 12 illustrates a method for transferring information regarding whether a reader device supports a fast transaction and regarding the reader device's access level according to an embodiment of the disclosure;

FIG. 13 illustrates a method for transferring information regarding whether a reader device supports a fast transaction and regarding the reader device's access level according to an embodiment of the disclosure;

FIG. 14 illustrates a method for transferring information regarding whether a reader device supports a fast transaction and regarding the reader device's access level according to an embodiment of the disclosure;

FIG. 15 illustrates signal flows in a provisioning step during a standard key sharing procedure according to an embodiment of the disclosure;

FIG. 16 illustrates signal flows in a transaction step during a standard key sharing procedure according to an embodiment of the disclosure;

FIG. 17 illustrates signal flows in a provisioning step during a medium key sharing procedure according to an embodiment of the disclosure;

FIG. 18 illustrates signal flows in a transaction step during a medium key sharing procedure according to an embodiment of the disclosure;

FIG. 19 illustrates signal flows in a provisioning step during a fast key sharing procedure according to an embodiment of the disclosure;

FIG. 20 illustrates signal flows in a transaction step during a fast key sharing procedure according to an embodiment of the disclosure;

FIG. 21 illustrates the order of operations of an owner terminal according to an embodiment of the disclosure; and

FIG. 22 illustrates the order of operations of a reader device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined based on the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, long term evolution (LTE) or long term evolution advanced (LTE-A) systems may be described by way of example, but the embodiments of the disclosure may also be applied to other communication systems having similar technical backgrounds or channel types. Examples of such communication systems may include 5^{th} generation mobile communication technologies (5G, and new radio (NR)) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. For example, the disclosure may be applied to a network related to the Aliro specification which is an open standard specification related to the Internet of things. Therefore, a wireless communication (or wired communication) system mentioned hereinafter in the disclosure may refer to not only a legacy wireless communication system, but also a communication system in a network specified by the Aliro specification.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in the embodiments may include one or more processors and/or devices.

In the following description, some of terms and names defined in the 3rd generation partnership project long term evolution (3GPP LTE)-based communication standards (e.g., standards for 5G, NR, LTE, and similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

The disclosure may be related to devices and methods specified in Aliro which is an open standard specification related to the Internet of things or Matter which is a standard specification related to smart home devices. The disclosure specifies a mobile access solution such that a user or a user device accesses a reader device. The disclosure may describe a method for enabling a user or a user device to access a reader device more quickly and conveniently. In addition, the disclosure may describe a method for enabling not only a user or a user device, but also a friend device to access a reader device more quickly.

Meanwhile, in the disclosure, a user or a user device may refer to a terminal or a terminal device (for example, including a UE, a MS, a cellular phone, a smartphone, a computer, or a multimedia system capable of performing communication function). Hereinafter, in the disclosure, a user, a user device, a terminal, a terminal device, a terminal unit, or an access device may all be used in the same meaning, and the above-mentioned terms may refer to devices of users for passing through gates for entry/exit. For convenience of description, the above-mentioned terms may simply be referred to as “terminals” hereinafter. Hereinafter, in the disclosure, reader devices or readers may refer to door locks or gates for entry/exit. In addition, the disclosure may describe a method wherein, besides a user device, another user device not validated by a reader device is enabled to share the user device's encryption key. Another user device enabled to share the user device's encryption key may be referred to as a friend user device or a guest user device. For convenience of description, a friend user device or a gest user device may also be referred to as a friend terminal or a guest terminal. In addition, a user device validated by a reader device may also be referred to as an owner user device to be distinguished from other user devices. However, the name of devices used in the disclosure is not limited to the above-mentioned examples, and may be modified and used in following embodiments of the disclosure.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

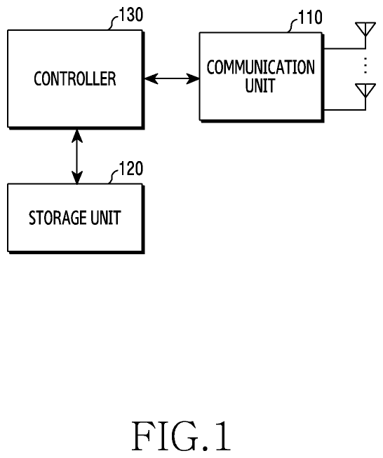

FIG. 1 illustrates the configuration of an Aliro network in a wireless communication system according to an embodiment of the disclosure.

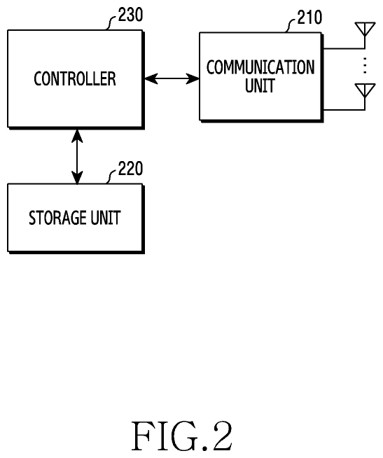

The configuration illustrated in FIG. 2 may be understood as a reader device's configuration. As used herein, the term “ . . . unit”/“-er” refers to a unit configured to process at least one function or operation, and may be implemented as hardware, software, or a combination of hardware and software.

Referring to FIG. 1, the Aliro network may include a communication unit 110, a storage unit 120, and a controller 130. However, components of the Aliro network are not limited to the communication unit 110, the storage unit 120, and the controller 130, and may include only some of the components or may include additional components.

The communication unit 110 provides an interface for communicating with other servers or devices (for example, terminals or reader devices) in the network. For example, the communication unit 110 may transmit and receive signals with other servers or devices in the network. Accordingly, the communication unit 110 may be referred to as a modem, a transmitter, a receiver, or a transceiver. The communication unit 110 enables the Aliro network to communicate with other devices via at least one interface.

The storage unit 120 stores data, such as basic programs for operations of the Aliro network, application programs, and configuration information. The storage unit 120 may be configured by volatile memory, nonvolatile memory, or a combination of volatile memory and nonvolatile memory. In addition, the storage unit 120 provides stored data at the request of the controller 130.

The controller 130 controls overall operations of the Aliro network. For example, the controller 130 transmits/receives signals through the communication unit 110. In addition, the controller 130 records and reads data in the storage unit 120. To this end, the controller 130 may include at least one processor. According to various embodiments of the disclosure, the controller 130 may control the Aliro network so as to perform operations according to various embodiments described later.

In addition to the above-described components, the Aliro network may also include a terminal-related security key management system (SKMS)/wallet server, a reader device-related reader system issuer server, and/or a credential issuer server.

The SKMS/wallet server may be configured to manage a security key and may be connected to a terminal of the disclosure so as to provide a service. The reader system issuer server may be connected to a reader device of the disclosure so as to manage a security key and to manage the reader device's fast transaction and access level. The credential issuer server may be configured to issue a terminal's credentials and to transfer an access document to a friend user terminal.

FIG. 2 illustrates the configuration of a reader device in a wireless communication system according to an embodiment of the disclosure.

The configuration illustrated in FIG. 2 may be understood as a reader device's configuration. As used herein, the term “ . . . unit”/“-er” refers to a unit configured to process at least one function or operation, and may be implemented as hardware, software, or a combination of hardware and software.

Referring to FIG. 2, the reader device may include a communication unit 210, a storage unit 220, and a controller 230. However, components of the reader device are not limited to the communication unit 210, the storage unit 220, and the controller 230, and may include only some of the components or may include additional components.

The communication unit 210 performs functions for transmitting/receiving signals through a radio channel. For example, the communication unit 210 performs functions of conversion between baseband signals and bitstrings according to the physical layer specifications of the system. For example, during data transmission, the communication unit 210 encodes and modulates a transmitted bitstring to generate complex symbols. In addition, during data reception, the communication unit 210 demodulates and decodes a baseband signal to restore a received bitstring. In addition, the communication unit 210 up-converts a baseband signal to an RF band signal, transmits the same through an antenna, and down-converts an RF band signal received through the antenna to a baseband signal. For example, the communication unit 210 may include a transmission filter, a reception filter, an amplifier, a mixer, an oscillator, a digital-to-analog converter (DAC), and an analog-to-digital converter (ADC).

In addition, the communication unit 210 may include multiple transmission/reception paths. Moreover, the communication unit 210 may include at least one antenna array configured by multiple antenna elements. In terms of hardware, the communication unit 210 may include a digital circuit and an analog circuit (for example, a radio frequency integrated circuit (RFIC)). The digital circuit and analog circuit may be implemented as a single package. In addition, the communication unit 210 may include multiple RF chains.

The communication unit 210 transmits and receives signals as described above. Accordingly, all or part of the communication unit 210 may be referred to as a “transmitter”, a “receiver”, or a “transceiver”. In addition, as used in the following description, “transmission and reception performed through a radio channel” include the meaning that the above-described processing is performed by the communication unit 210.

The storage unit 220 stores data, such as basic programs for operations of the reader device, application programs, and configuration information. The storage unit 220 may be configured by volatile memory, nonvolatile memory, or a combination of volatile memory and nonvolatile memory. In addition, the storage unit 220 provides stored data at the request of the controller 230.

The controller 230 controls overall operations of the reader device. For example, the controller 230 transmits/receives signals through the communication unit 210. In addition, the controller 230 records and reads data in the storage unit 220. In addition, the controller 230 may perform functions of protocol stacks required by communication specifications. To this end, the controller 230 may include at least one processor or microprocessor, or may be a part of a processor. In addition, a part of the communication unit 210 and the controller 230 may be referred to as a communication processor (CP). According to various embodiments of the disclosure, the controller 230 may control the reader device so as to perform operations according to various embodiments described later.

In addition, the reader device may be connected to a terminal through a radio link (for example, Wi-Fi or radio frequency (RF)). Therefore, the reader device and the terminal may transmit and/or receive necessary information through servers described with reference to FIG. 1.

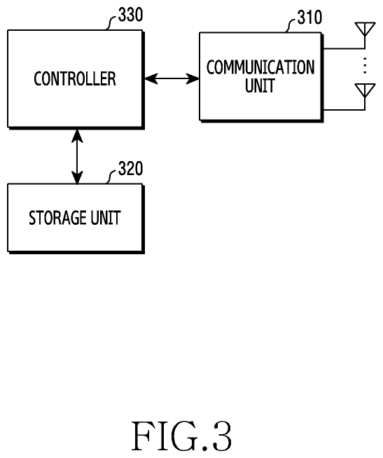

FIG. 3 illustrates the configuration of a terminal in a wireless communication system according to an embodiment of the disclosure.

The configuration illustrated in FIG. 3 may be understood as a terminal's configuration. As used herein, the term “ . . . unit”/“-er” refers to a unit configured to process at least one function or operation, and may be implemented as hardware, software, or a combination of hardware and software.

Referring to FIG. 3, the terminal may include a communication unit 310, a storage unit 320, and a controller 330. However, components of the terminal are not limited to the communication unit 310, the storage unit 320, and the controller 330, and may include only some of the components or may include additional components.

The communication unit 310 performs functions for transmitting/receiving signals through a radio channel. For example, the communication unit 310 performs functions of conversion between baseband signals and bitstrings according to the physical layer specifications of the system. For example, during data transmission, the communication unit 310 encodes and modulates a transmitted bitstring to generate complex symbols. In addition, during data reception, the communication unit 310 demodulates and decodes a baseband signal to restore a received bitstring. In addition, the communication unit 310 up-converts a baseband signal to an RF band signal, transmits the same through an antenna, and down-converts an RF band signal received through the antenna to a baseband signal. For example, the communication unit 310 may include a transmission filter, a reception filter, an amplifier, a mixer, an oscillator, a DAC, and an ADC.

In addition, the communication unit 310 may include multiple transmission/reception paths. Moreover, the communication unit 310 may include at least one antenna array configured by multiple antenna elements. In terms of hardware, the communication unit 310 may include a digital circuit and an analog circuit (for example, a radio frequency integrated circuit (RFIC)). The digital circuit and analog circuit may be implemented as a single package. In addition, the communication unit 310 may include multiple RF chains.

The communication unit 310 transmits and receives signals as described above. Accordingly, all or part of the communication unit 310 may be referred to as a “transmitter”, a “receiver”, or a “transceiver”. In addition, as used in the following description, “transmission and reception performed through a radio channel” include the meaning that the above-described processing is performed by the communication unit 310.

The storage unit 320 stores data, such as basic programs for operations of the terminal, application programs, and configuration information. The storage unit 320 may be configured by volatile memory, nonvolatile memory, or a combination of volatile memory and nonvolatile memory. In addition, the storage unit 320 provides stored data at the request of the controller 330.

The controller 330 controls overall operations of the terminal. For example, the controller 330 transmits/receives signals through the communication unit 310. In addition, the controller 330 records and reads data in the storage unit 320. In addition, the controller 330 may perform functions of protocol stacks required by communication specifications. To this end, the controller 330 may include at least one processor or microprocessor, or may be a part of a processor. In addition, a part of the communication unit 310 and the controller 330 may be referred to as a communication processor (CP). According to various embodiments of the disclosure, the controller 330 may control the terminal so as to perform operations according to various embodiments described later.

In addition, the terminal may be connected to another terminal (for example, friend terminal) and/or the reader device through a radio link (for example, Wi-Fi or radio frequency (RF)). Therefore, the terminal and the reader device may transmit and/or receive necessary information through servers described with reference to FIG. 1.

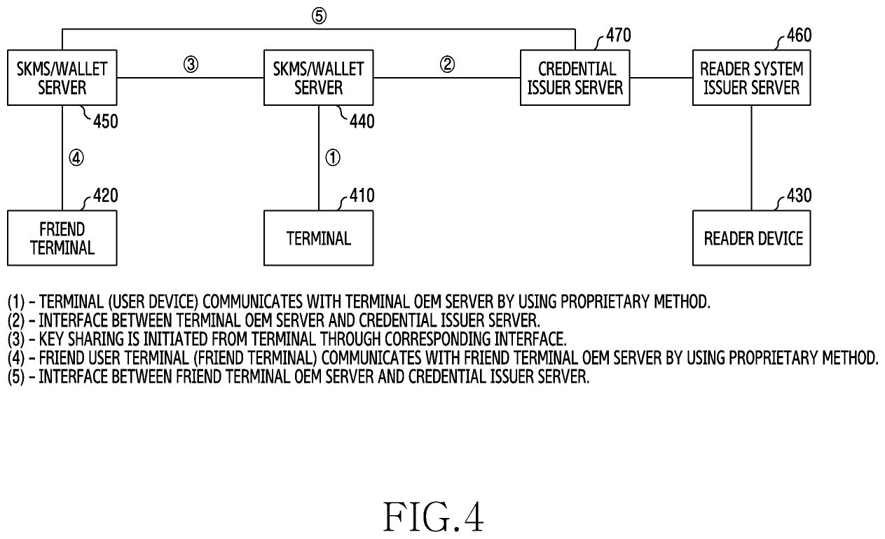

FIG. 4 illustrates the configuration of a network configured such that a friend terminal accesses a reader device in a wireless communication system according to an embodiment of the disclosure.

FIG. 4 may be referenced to describe the structure of a network in which a terminal (for example, owner terminal), a friend terminal, and a reader device are connected by radio links through at least one server. A terminal 410 and the friend terminal 420 may be connected to SKMS/wallet servers 440 and 450 by radio links, respectively. The terminals 410 and 420 may be connected to the SKMS/wallet servers 440 and 450 by using an exclusive or proprietary method (for example, dedicated interface). The SKMS/wallet servers 440 and 450 may be original equipment manufacturer (OEM) servers connected to third party servers provided by external operators. A key between the terminals 410 and 420 may be shared between the SKMS/wallet servers 440 and 450 through an inter-server interface. For example, the terminal 410 may transfer its key to the friend terminal 420 if a fast transaction according to the disclosure (described later) is supported, and the key of the terminal 410 may be transferred through the SKMS/wallet servers 440 and 450 and the inter-server interface. A reader device 430 may be connected to a reader system issuer server 460 through a radio link. The reader system issuer server may be connected to a credential issuer server 470. The credential issuer server may be connected to each of the SKMS/wallet servers 440 and 450 such that data is transmitted and/or received through a separate interface.

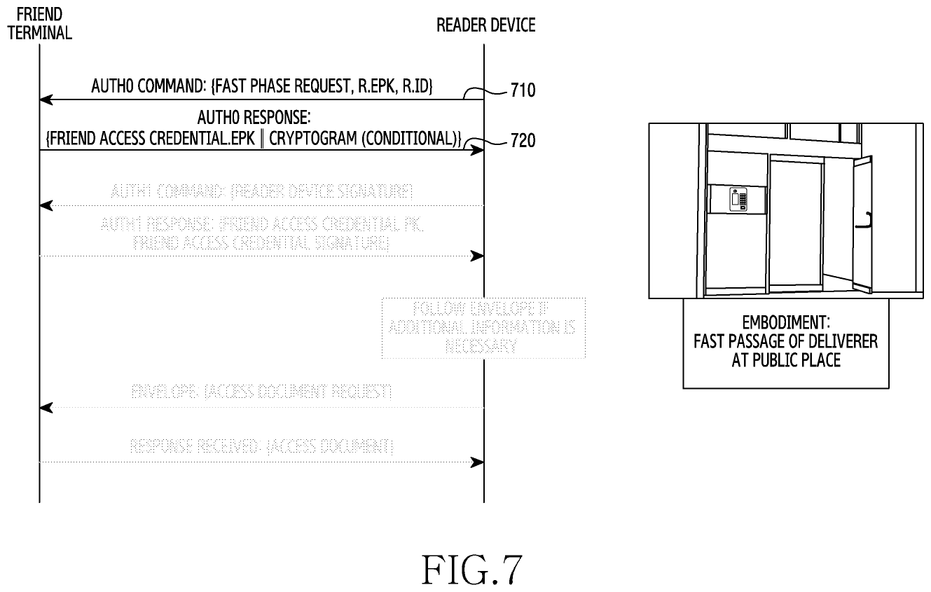

Obviously, components of the network according to an embodiment of the disclosure are not limited to the above example, and at least one entity (for example, server or device) may be added. In addition, the names of the servers 440, 450, 460, and 470 are not limited to the above names, and may be replaced with other servers which provide an interface for transmission and/or reception of data between the entities 410 to 470 constituting the network. The interface between the entities 410 to 470 constituting the network in FIG. 4 may be configured by a wireless or wired interface. In addition, the entities 410 to 470 constituting the network in FIG. 7 may be the above-described devices or servers in FIGS. 1 to 3.

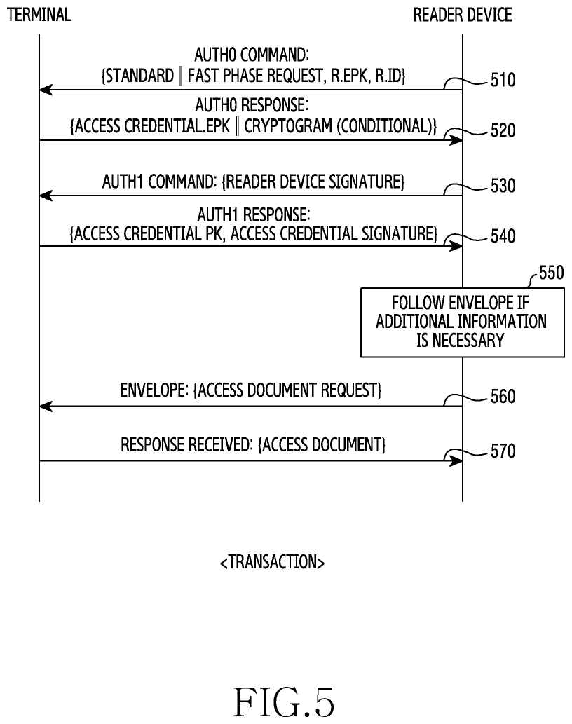

FIG. 5 illustrates signal flows during a transaction between a terminal and a reader device according to an embodiment of the disclosure.

Referring to FIG. 5, the terminal may access the reader device through an authorization (operations 510 to 540 described later). If additional information (for example, a validation period, a period of time for which access is possible) is necessary, the reader device may further perform an operation for requesting the terminal to provide an access document (operations 550 to 570 described later). Prior to the operations in FIG. 5, the terminal and the reader device may perform provisioning such that a necessary key value (for example, shared key or public key (PK)) is shared with each other.

More specifically, in operation 510, the reader device may transmit an authorization (AUTH0) command to the terminal. In an embodiment of the disclosure, the authorization command may include a request for a standard phase (for example, standard transaction) or a fast phase (for example, fast transaction). In addition, the authorization command may include the reader device's ephemeral public key (reader.ephemeral public key (R.ePK)) and the reader device's identifier (ID) (R.ID). The reader device's ID may include a reader device group identifier (reader group ID) and a reader device group sub-identifier (reader group sub-ID). The reader device group sub-identifier may be information for selecting (or identifying) the Kpersistent stored in the terminal matched with the reader device's Kpersistent. As used herein, the Kpersistent may refer to a symmetric value generated in the terminal and the reader device, based on a key value exchanged in the course of AUTH0 and AUTH1 transactions between the terminal and the reader device. For example, the terminal may transmit a cryptogram derived from the Kpersistent instead of transmitting the Kpersistent to the reader device. In an embodiment of the disclosure, if the matched Kpersistent is selected, the terminal may derive a cryptogram and transmit the same to the reader device. In an embodiment of the disclosure, information regarding the reader device group sub-identifier may be stored in the terminal in a combination format, such as reader group sub ID-Kpersistent.

In operation 520, the terminal may transmit an AUTH0 response to the AUTH0 command in operation 510 to the reader device. The AUTH0 response may include a cryptogram encrypted through an access credential ephemeral public key (access credential.ePK) or a public key. The cryptogram may be included conditionally. The reason the cryptogram is included conditionally in the AUTH0 response may be because the terminal transfers the cryptogram only if the reader device which supports a fast transaction request the terminal to provide the cryptogram through an AUTH0 command. In following embodiments of the disclosure, a cryptogram may be included conditionally in a response to an authorization command as described above. The reader device may identify whether the cryptogram is valid by utilizing the Kpersistent stored therein.

In operation 530, the reader device may transmit an AUTH1 command to the terminal. The AUTH1 command may include the reader device's signature (reader signature). The reader device may decrypt the cryptogram received from the terminal in operation 520 through the reader device's secrete key or private key (SK). The private key may have the same meaning as a secret key or SK, as a key value for decrypting a cryptogram encrypted through a shared key.

In operation 540, the terminal may transmit an AUTH1 response to the AUTH1 command in operation 530 to the reader device. The AUTH1 response may include an access credential PK and an access credential signature. The terminal may authorize or identify the reader device through the reader device signature received from the reader device in operation 530. In addition, the reader device may authorize or identify the terminal through the access credential signature included in the AUTH1 response.

Through operations 510 to 540 described above, the reader device may authorize a terminal which wants to gain access. The reader device may allow the terminal's access through an authorization procedure. If additional information is necessary for the terminal's access, the reader device may follow an envelope in operation 550.

In operation 560, the reader device may transmit an envelope including a request for an access document to the terminal. The envelope may include access-related additional information (for example, validation period, a period of time for which access is possible) which the reader device requests the terminal to provide.

In operation 570, the terminal may transmit an access document to the reader device in response to the access document request. The access document may include additional information (for example, validation period, a period of time for which access is possible) requested by the reader device. The access document transmitted by the terminal may be information received and stored by the terminal from the credential issuer server in a provisioning procedure prior to the transaction described above. For example, the reader device may identify a period of time for which access is possible by the terminal authorized through the authorization procedure described above (operations 510 to 540), based on information included in the access document.

Operations 560 to 570 described above may be a procedure which may be performed additionally as needed by the reader device, unlike the terminal's authorization procedure (operations 510 to 540) described above. Therefore, the procedures for access document request and response may be omitted.

Obviously, the above example is not limitative. Some or all of at least one operation of the transaction in the embodiment described above may be combined or modified. Alternatively, at least one operation may be deleted, or a new procedure may be added and organically combined with the above-described operations.

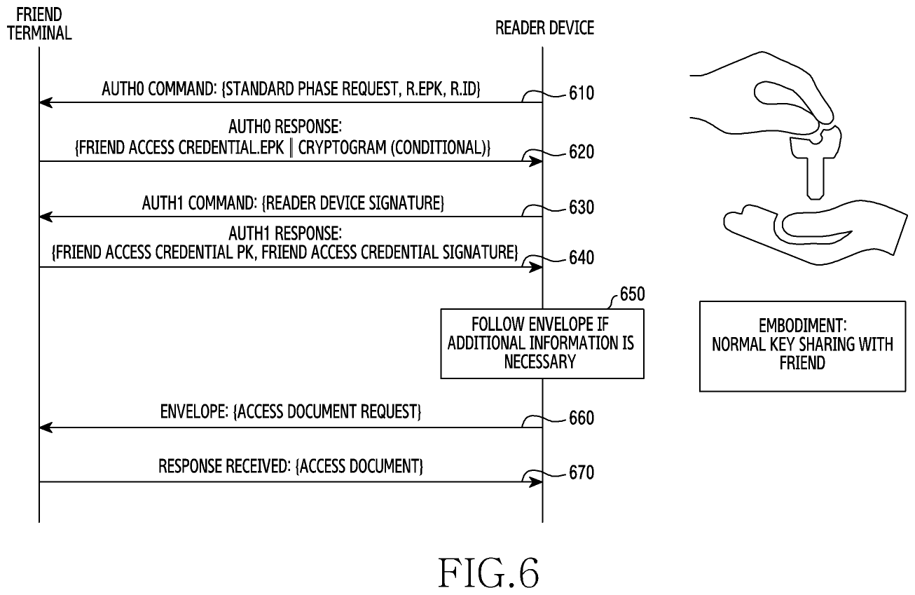

FIG. 6 illustrates signal flows during a transaction between a friend terminal and a reader device according to an embodiment of the disclosure.

Referring to FIG. 6, the friend terminal may access the reader device through an authorization (operations 610 to 640 described later). If additional information (for example, a validation period, a period of time for which access is possible) is necessary, the reader device may further perform an operation for requesting the friend terminal to provide an access document (operations 650 to 670 described later). The friend terminal may perform the transaction (for examples, operations 510 to 570) between the (owner) terminal and the reader device in FIG. 5 in an identical or similar manner.

More specifically, in operation 610, the reader device may transmit an authorization (AUTH0) command to the friend terminal. In an embodiment of the disclosure, the authorization command may include a request for a standard phase (for example, standard transaction). In addition, the authorization command may include the reader device's ephemeral public key (R.ePK)) and the reader device's identifier (R.ID). The reader device's identifier may include a reader device group identifier and a reader device group sub-identifier. The reader device group sub-identifier may be information for selecting (or identifying) the Kpersistent stored in the friend terminal matched with the reader device's Kpersistent. As used herein, the Kpersistent may refer to a symmetric value generated in the friend terminal and the reader device, based on a key value exchanged in the course of AUTH0 and AUTH1 transactions between the friend terminal and the reader device. For example, the friend terminal may transmit a cryptogram derived from the Kpersistent instead of transmitting the Kpersistent to the reader device. In an embodiment of the disclosure, if the matched Kpersistent is selected, the friend terminal may derive a cryptogram and transmit the same to the reader device. In an embodiment of the disclosure, information regarding the reader device group sub-identifier may be stored in the friend terminal in a combination format, such as reader group sub ID-Kpersistent.

In operation 620, the friend terminal may transmit an AUTH0 response to the AUTH0 command in operation 610 to the reader device. The response may include a cryptogram encrypted through a friend access credential ephemeral public key (credential.ePK) or a public key. The cryptogram may be included conditionally. In addition, the public key may be identical to the owner terminal's public key. The reader device may identify whether the cryptogram is valid by utilizing the Kpersistent stored therein.

In operation 630, the reader device may transmit an AUTH1 command to the friend terminal. The AUTH1 command may include the reader device's signature (reader signature). The reader device may decrypt the cryptogram received from the friend terminal in operation 620 through the reader device's private key or secrete key.

In operation 640, the friend terminal may transmit an AUTH1 response to the AUTH1 command in operation 630 to the reader device. The AUTH1 response may include a friend access credential PK and a friend access credential signature. The friend terminal may authorize or identify the reader device through the reader device signature received from the reader device in operation 630. In addition, the reader device may authorize or identify the friend terminal through the access credential signature included in the AUTH1 response.

Through operations 610 to 640 described above, the reader device may authorize a friend terminal which wants to gain access. If additional information is necessary for the friend terminal's access, the reader device may follow an envelope in operation 650.

In operation 660, the reader device may transmit an envelope including a request for an access document to the friend terminal. The envelope may include access-related additional information (for example, validation period, a period of time for which access is possible) which the reader device requests the terminal to provide.

In operation 670, the friend terminal may transmit an access document to the reader device in response to the access document request. The access document may include additional information (for example, validation period, a period of time for which access is possible) requested by the reader device. The access document transmitted by the friend terminal may be information received and stored by the friend terminal from the credential issuer server in a provisioning procedure prior to the transaction described above. For example, the reader device may identify a period of time for which access is possible by the friend terminal authorized through the authorization procedure described above (operations 610 to 640), based on information included in the access document.

Operations 660 to 670 described above may be a procedure which may be performed additionally as needed by the reader device, unlike the friend terminal's authorization procedure (operations 610 to 640) described above. Therefore, the procedures for access document request and response may be omitted.

Referring back to FIG. 6, the friend terminal may perform the above-described transaction between the (owner) terminal and the reader device in FIG. 5 in an identical or similar manner. Therefore, in order to access the reader device, the friend terminal may have to perform both AUTH0 and AUTH1 procedures as in the case of the owner terminal.

Obviously, the above example is not limitative. Some or all of at least one operation of the transaction in the embodiment described above may be combined or modified. Alternatively, at least one operation may be deleted, or a new procedure may be added and organically combined with the above-described operations.

FIG. 7 illustrates signal flows during a transaction between a friend terminal and a reader device according to an embodiment of the disclosure.

Referring to FIG. 7, the friend terminal may access the reader device through an authorization (operations 710 to 720 described later). In an embodiment of the disclosure, the friend terminal may perform only an AUTH0 authorization procedure according to a fast transaction with the reader device. Therefore, descriptions overlapping those in FIG. 6 may be omitted herein. Therefore, the friend terminal may request the reader device to provide an access right without cryptogram and additional authorization procedures (for example, AUTH1 command/response). In an embodiment of the disclosure, the access level of the reader device which the friend terminal wants to access may be defined. The owner terminal may determine whether or not to transfer a cryptogram to the friend terminal, based on the access level. For example, the fast transaction may be a transaction shortened such that a deliverer can quickly access a specific gate or reader at a common entrance of a multi-dwelling unit or at a public place. However, it may be assumed that, through a standard transaction between the owner terminal and the reader device, the friend terminal has exchanged a shared key with each.

More specifically, in operation 710, the reader device may transmit an authorization (AUTH0) command to the friend terminal. In an embodiment of the disclosure, the authorization command may include a request for a fast phase (for example, fast transaction). In addition, the authorization command may include the reader device's ephemeral public key (R.ePK)) and the reader device's identifier (R.ID). The reader device's identifier may include a reader device group identifier and a reader device group sub-identifier.

In operation 720, the friend terminal may transmit an AUTH0 response to the AUTH0 command in operation 710 to the reader device. The response may include a cryptogram encrypted through a friend access credential ephemeral public key (credential.ePK) or a public key. The cryptogram may be included conditionally. In addition, the public key may be identical to the owner terminal's public key. The reader device may identify whether the cryptogram is valid by utilizing the Kpersistent stored therein.

Referring back to FIG. 7, the friend terminal may perform only the AUTH0 authorization procedure as a fast transaction, unlike the friend terminal described with reference to FIG. 6. Therefore, the friend terminal may access the reader device more quickly. In addition, through the fast transaction, delay and signaling overhead due to procedures related to AUTH1 signaling and access documents may be reduced.

Obviously, the above example is not limitative. Some or all of at least one operation of the transaction in the embodiment described above may be combined or modified. Alternatively, at least one operation may be deleted, or a new procedure may be added and organically combined with the above-described operations.

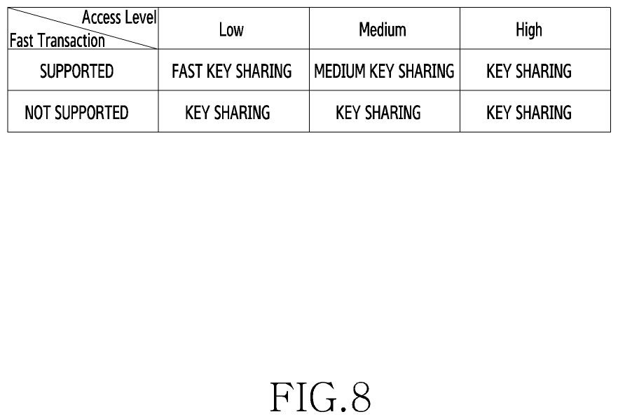

FIG. 8 illustrates classification of key sharing types according to a fast transaction and an access level according to an embodiment of the disclosure.

Referring to FIG. 8, key sharing procedures may be classified into normal key sharing, medium key sharing, and fast key sharing according to whether a reader device supports a fast transaction and according to the access level. The reader device's access level may be defined according to the reader device's security level or reliability. For example, in the case of a reader device installed at a public place frequented by an unspecified multitude, or at a place having a low security level, such as a common entrance of a multi-dwelling unit, the reader device may have a low access level configured therefor. Alternatively, in the case of a reader device installed at a place having a high security level such that only authorized devices are allowed to access, the reader device may have a high access level configured therefor. In addition, the reader device's access level may be defined in three steps of low, medium, and high as illustrated in FIG. 8. However, the reader device's access level is not necessarily limited to the three steps mentioned above, and respective steps may have different ranges.

In an embodiment of the disclosure, if the reader device does not support a fast transaction, or if the reader device has a high access level although the reader device supports a fast transaction, a normal key sharing (or standard key sharing) procedure may be conducted. For example, the friend terminal may have to perform both AUTH0 and AUTH1 authorization procedures to access the reader device.

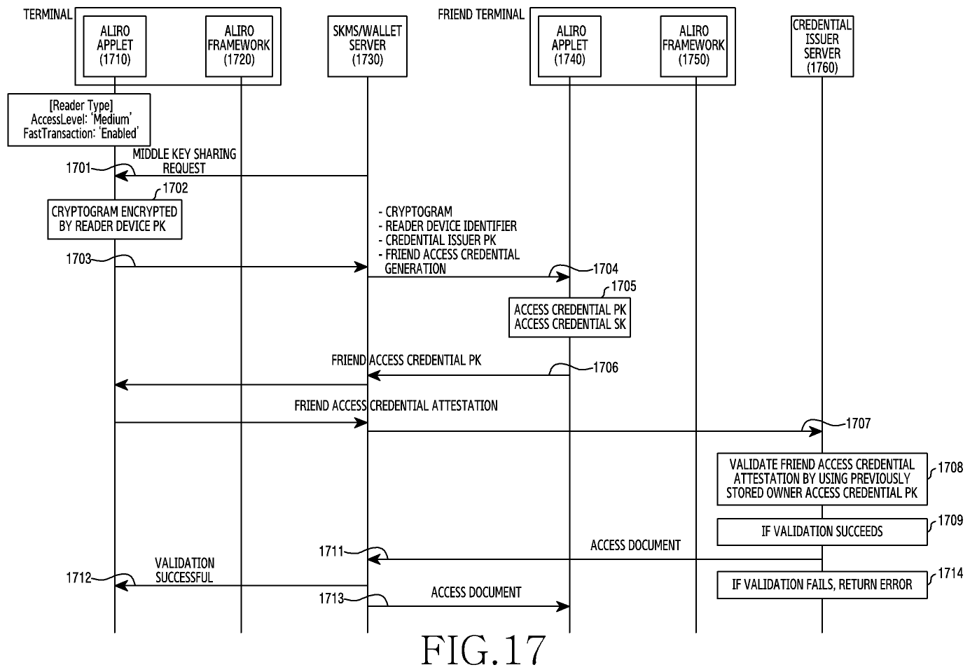

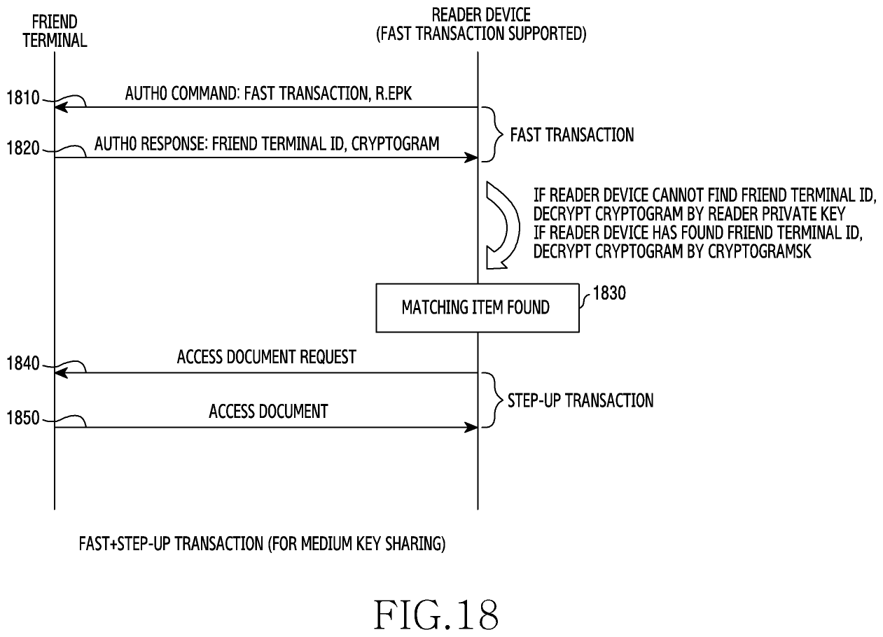

In an embodiment of the disclosure, if the reader device supports a fast transaction, and if the reader device's access level is medium, a medium key sharing procedure may be performed. For example, the owner terminal may directly transfer a cryptogram encrypted by the reader device's shared key to the friend terminal. The friend terminal may access the reader device through the owner terminal's cryptogram. Therefore, the middle key sharing procedure may have at least one procedure omitted, compared with the standard key sharing procedure. The middle key sharing procedure will be described below with reference to FIGS. 17 and 18.

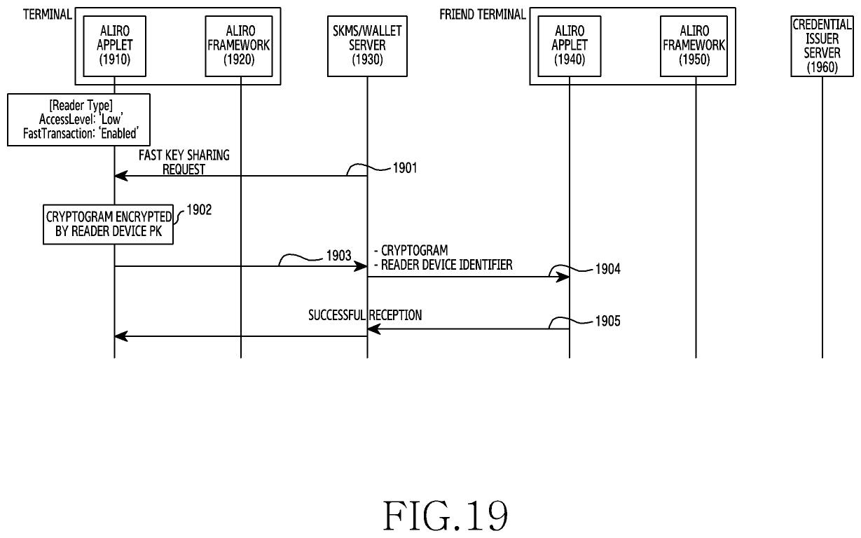

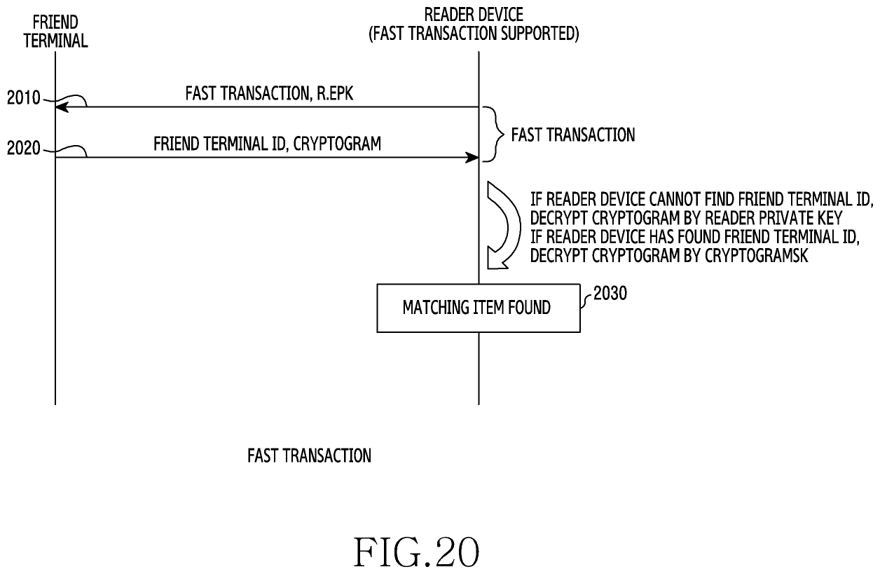

In an embodiment of the disclosure, if the reader device supports a fast transaction, and if the reader device's access level is low, a fast key sharing procedure may be performed. For example, the owner terminal may transfer a cryptogram generated by itself, and the friend terminal may access the reader device through the owner terminal's cryptogram without validating the owner terminal's signature. The fast key sharing procedure will be described below with reference to FIGS. 19 and 20.

The owner terminal may determine which key sharing procedure is to be performed, among the above-described key sharing procedures, according to whether the reader device supports a fast transaction and according to the access level. However, the above-described embodiments are only examples in which the reader device's access level is classified into three steps, and are not limited to such examples. Therefore, the reader device's access level may be classified into two steps or four or more steps, and the key sharing procedure may be distinguished according to each step.

Meanwhile, information regarding whether the reader device supports a fast transaction and regarding the reader device's access level may be transferred to the owner terminal according to at least one of the following methods:

In an embodiment of the disclosure, information regarding whether the reader device supports a fast transaction and regarding the reader device's access level may be transferred in a provisioning step (for example, provisioning between the owner terminal and the reader device). For example, the reader system issuer server may transfer information regarding whether the reader device supports a fast transaction and regarding the reader device's access level to the credential issuer server. The credential issuer server may transfer information received from the reader system issuer server to the SKMS/wallet server. The owner terminal may then receive information regarding whether the reader device supports a fast transaction and regarding the reader device's access level from the SKMS/wallet server.

In an embodiment of the disclosure, information regarding whether the reader device supports a fast transaction and regarding the reader device's access level may be transferred in a transaction step (for example, transaction between the owner terminal and the reader device). For example, information regarding whether the reader device supports a fast transaction and regarding the reader device's access level may be included in an AUTH0 command, AUTH1 command, or EXCHANGE command in the transaction step and transmitted to the owner terminal.

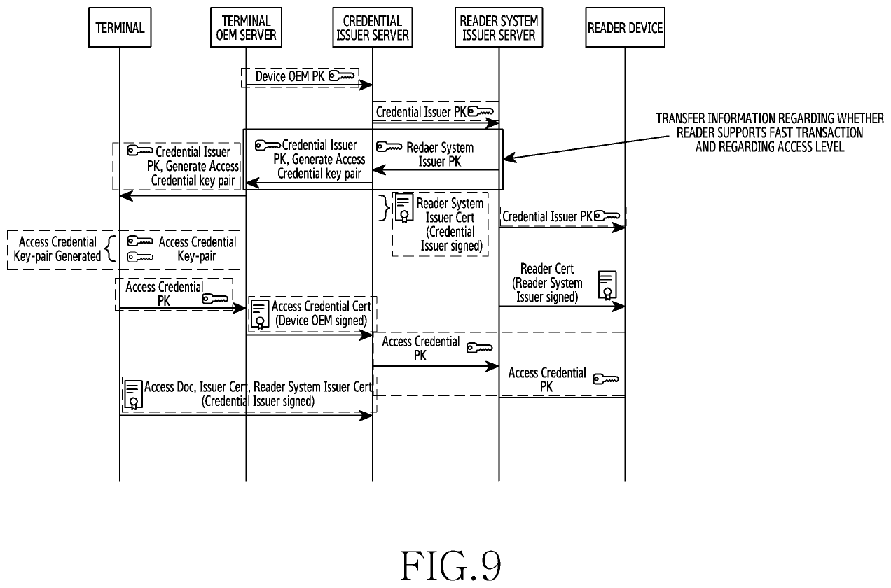

FIG. 9 illustrates a method for transferring information regarding whether a reader device supports a fast transaction and regarding the reader device's access level according to an embodiment of the disclosure.

FIG. 9 may be referenced to describe a method for transferring the information regarding whether the reader device supports a fast transaction and regarding the reader device's access level in the embodiment described with reference to FIG. 8 in the provisioning step (for example, provisioning between the owner terminal and the reader device). The reader system issuer server may transmit a reader system issuer PK to the credential issuer server. The credential issuer server may transmit a credential issuer PK to the terminal OEM server (for example, SKMS/wallet server). The credential issuer server may further include and transmit a message to instruct the terminal OEM server to generate a credential key pair. In an embodiment of the disclosure, the information regarding whether the reader device supports a fast transaction and regarding the reader device's access level may be transmitted together during the above-described signaling.

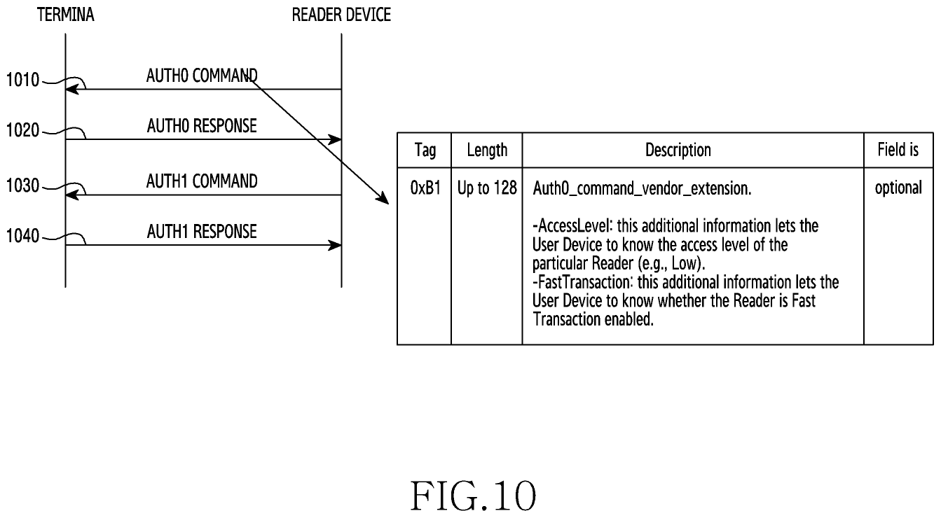

FIG. 10 illustrates a method for transferring information regarding whether a reader device supports a fast transaction and regarding the reader device's access level according to an embodiment of the disclosure.

FIG. 10 may be referenced to describe a method for transferring the information regarding whether the reader device supports a fast transaction and regarding the reader device's access level in the embodiment described with reference to FIG. 8 in the transaction step (for example, transaction between the owner terminal and the reader device). Operations 1010 to 1040 described below may correspond to the same signaling as operations 510 to 540 in FIG. 5 described above. In addition, the terminal in FIG. 10 may be an owner terminal supposed to determine whether or not to transfer a cryptogram to the friend terminal according to a fast transaction. Therefore, descriptions overlapping those in FIG. 5 may be omitted herein.

In operation 1010, the reader device may transmit an AUTH0 command to the terminal. In an embodiment of the disclosure, the AUTH0 command may include the reader device's ephemeral public key (R.ePK) and the reader device's identifier (R.ID). In an embodiment of the disclosure, the AUTH0 command may include an extension field including at least one of information regarding whether the reader device supports a fast transaction or information regarding the access level. The extension field may have a size of a maximum of 128 bits.

In operation 1020, the terminal may transmit an AUTH0 response to the AUTH0 command in operation 1010 to the reader device. The AUTH0 response may include an access credential public key or a cryptogram encrypted through the public key. The cryptogram may be included conditionally. The reader device may identify whether the cryptogram is valid by utilizing the Kpersistent stored therein.

In operation 1030, the reader device may transmit an AUTH1 command to the terminal. The AUTH1 command may include the reader device's signature. The reader device may decrypt the cryptogram received from the terminal in operation 1020 through the reader device's private key (or secret key).

In operation 1040, the terminal may transmit an AUTH1 response to the AUTH1 command in operation 1030 to the reader device. The AUTH1 response may include an access credential public key and an access credential signature. The terminal may authorize or identify the reader device through the reader device signature received from the reader device in operation 1030. In addition, the reader device may authorize or identify the terminal through the access credential signature included in the AUTH1 response.

Obviously, the above example is not limitative. Some or all of at least one operation of the transaction in the embodiment described above may be combined or modified. Alternatively, at least one operation may be deleted, or a new procedure may be added and organically combined with the above-described operations.

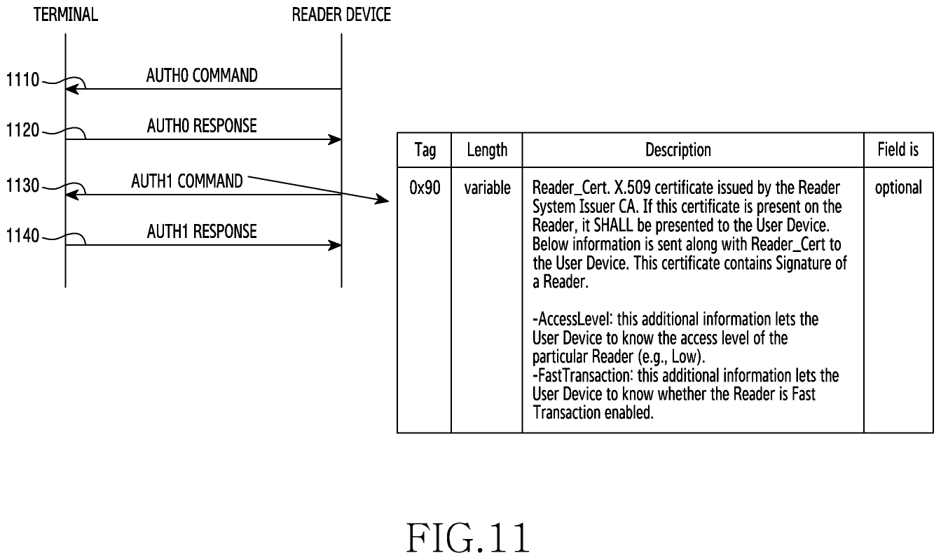

FIG. 11 illustrates a method for transferring information regarding whether a reader device supports a fast transaction and regarding the reader device's access level according to an embodiment of the disclosure.

FIG. 11 may be referenced to describe a method for transferring the information regarding whether the reader device supports a fast transaction and regarding the reader device's access level in the embodiment described with reference to FIG. 8 in the transaction operation (for example, transaction between the owner terminal and the reader device). Operations 1110 to 1140 described below may correspond to the same signaling as operations 510 to 540 in FIG. 5 described above. In addition, the terminal in FIG. 11 may be an owner terminal supposed to determine whether or not to transfer a cryptogram to the friend terminal according to a fast transaction. Therefore, descriptions overlapping those in FIG. 5 may be omitted herein.

In operation 1110, the reader device may transmit an AUTH0 command to the terminal. In an embodiment of the disclosure, the AUTH0 command may include the reader device's ephemeral public key (R.ePK) and the reader device's identifier (R.ID).

In operation 1120, the terminal may transmit an AUTH0 response to the AUTH0 command in operation 1110 to the reader device. The AUTH0 response may include an access credential public key or a cryptogram encrypted through the public key. The cryptogram may be included conditionally. The reader device may identify whether the cryptogram is valid by utilizing the Kpersistent stored therein.

In operation 1130, the reader device may transmit an AUTH1 command to the terminal. The AUTH1 command may include the reader device's signature. The reader device may decrypt the cryptogram received from the terminal in operation 1120 through the reader device's private key (or secret key). In an embodiment of the disclosure, the AUTH1 command may include a credential-related field including at least one of information regarding whether the reader device supports a fast transaction or information regarding the access level.

In operation 1140, the terminal may transmit an AUTH1 response to the AUTH1 command in operation 1130 to the reader device. The AUTH1 response may include an access credential public key and an access credential signature. The terminal may authorize or identify the reader device through the reader device signature received from the reader device in operation 1130. In addition, the reader device may authorize or identify the terminal through the access credential signature included in the AUTH1 response.

Obviously, the above example is not limitative. Some or all of at least one operation of the transaction in the embodiment described above may be combined or modified. Alternatively, at least one operation may be deleted, or a new procedure may be added and organically combined with the above-described operations.

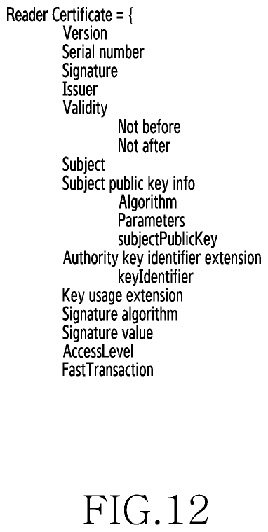

FIG. 12 illustrates a method for transferring information regarding whether a reader device supports a fast transaction and regarding the reader device's access level according to an embodiment of the disclosure.

Referring to FIG. 12, assuming that information regarding whether the reader device supports a fast transaction and regarding the reader device's access level is transferred to the terminal through an AUTH1 command according to the embodiment described with reference to FIG. 11, the configuration of information regarding the reader device's credential included in the AUTH1 command is illustrated.

The reader device's credential may include at least one of a version, a serial number, a signature, an issuer, a period of validity (before or after), a subject, subject public key information (algorithm, parameters, subject public key), an authorization key identifier extension (key identifier), a key usage extension, a signature algorithm, or a signature value. However, the example is not limitative, and the configuration of the credential may include at least one of the above parameters or further include at least one other parameter. In an embodiment of the disclosure, the reader device's credential may further include a parameter regarding at least one of an access level or a fast transaction.

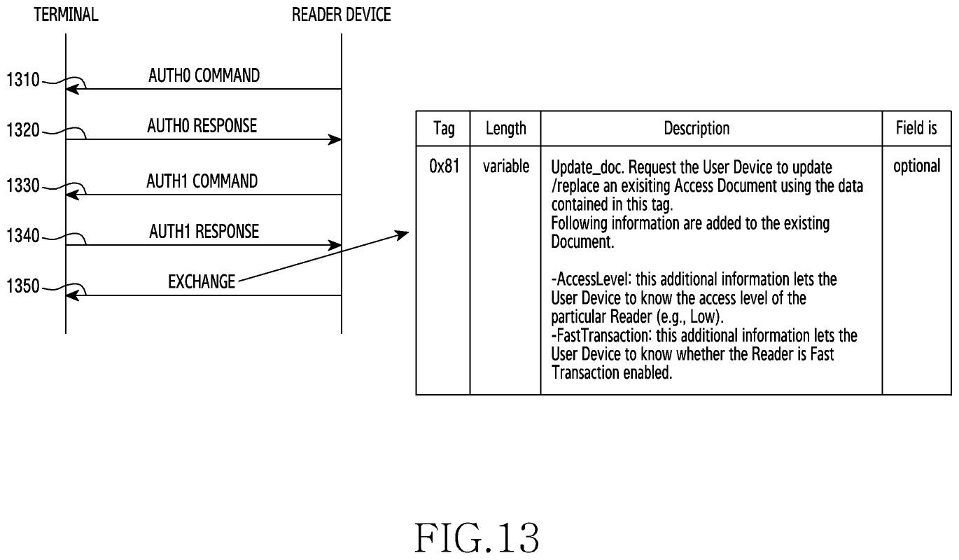

FIG. 13 illustrates a method for transferring information regarding whether a reader device supports a fast transaction and regarding the reader device's access level according to an embodiment of the disclosure.

FIG. 13 may be referenced to describe a method for transferring the information regarding whether the reader device supports a fast transaction and regarding the reader device's access level in the embodiment described with reference to FIG. 8 in the transaction step (for example, transaction between the owner terminal and the reader device). Operations 1310 to 1340 described below may correspond to the same signaling as operations 510 to 540 in FIG. 5 described above. In addition, the terminal in FIG. 13 may be an owner terminal supposed to determine whether or not to transfer a cryptogram to the friend terminal according to a fast transaction. Therefore, descriptions overlapping those in FIG. 5 may be omitted herein.

In operation 1310, the reader device may transmit an AUTH0 command to the terminal. In an embodiment of the disclosure, the AUTH0 command may include the reader device's ephemeral public key (R.ePK) and the reader device's identifier (R.ID).

In operation 1320, the terminal may transmit an AUTH0 response to the AUTH0 command in operation 1310 to the reader device. The AUTH0 response may include an access credential public key or a cryptogram encrypted through the public key. The cryptogram may be included conditionally. The reader device may identify whether the cryptogram is valid by utilizing the Kpersistent stored therein.

In operation 1330, the reader device may transmit an AUTH1 command to the terminal. The AUTH1 command may include the reader device's signature.

In operation 1340, the terminal may transmit an AUTH1 response to the AUTH1 command in operation 1330 to the reader device. The AUTH1 response may include an access credential public key and an access credential signature. The terminal may authorize or identify the reader device through the reader device signature received from the reader device in operation 1330. In addition, the reader device may authorize or identify the terminal through the access credential signature included in the AUTH1 response.

In operation 1350, the reader device may transmit an EXCHANGE command to the terminal. The EXCHANGE command may be intended to request update regarding an access document which the terminal has received from the credential issuer server and then stored therein. The EXCHANGE command may include information for updating the access document stored in the terminal. In an embodiment of the disclosure, the EXCHANGE command may further include at least one of information regarding whether the reader device supports a fast transaction or information regarding the access level.

Obviously, the above example is not limitative. Some or all of at least one operation of the transaction in the embodiment described above may be combined or modified. Alternatively, at least one operation may be deleted, or a new procedure may be added and organically combined with the above-described operations.

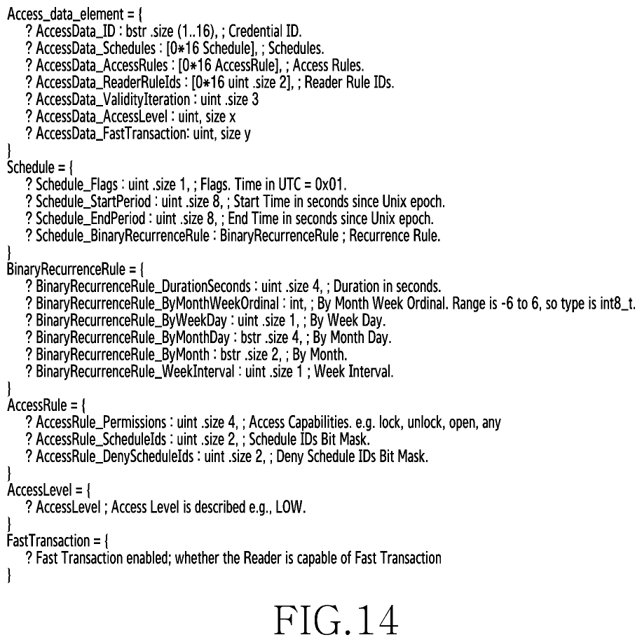

FIG. 14 illustrates a method for transferring information regarding whether a reader device supports a fast transaction and regarding the reader device's access level according to an embodiment of the disclosure.

Referring to FIG. 14, assuming that information regarding whether the reader device supports a fast transaction and regarding the reader device's access level is transferred to the terminal through an EXCHANGE command according to the embodiment described with reference to FIG. 13, the configuration of information regarding the EXCHANGE command is illustrated.

The EXCHANGE command may include at least one of an access information element (Access_data_element), a schedule, a binary recurrence rule (BinaryRecurrenceRule), or an access rule (AccessRule). However, the example is not limitative, and the EXCHANGE command may include at least one of the above parameters or further include at least one other parameter. In an embodiment of the disclosure, the EXCHANGE command may further include a parameter regarding at least one of an access level or a fast transaction. In an embodiment of the disclosure, the access information element may further include information regarding the unit and size of a parameter regarding the access level, and information regarding the unit and size of a parameter regarding whether a fast transaction is supported or not.

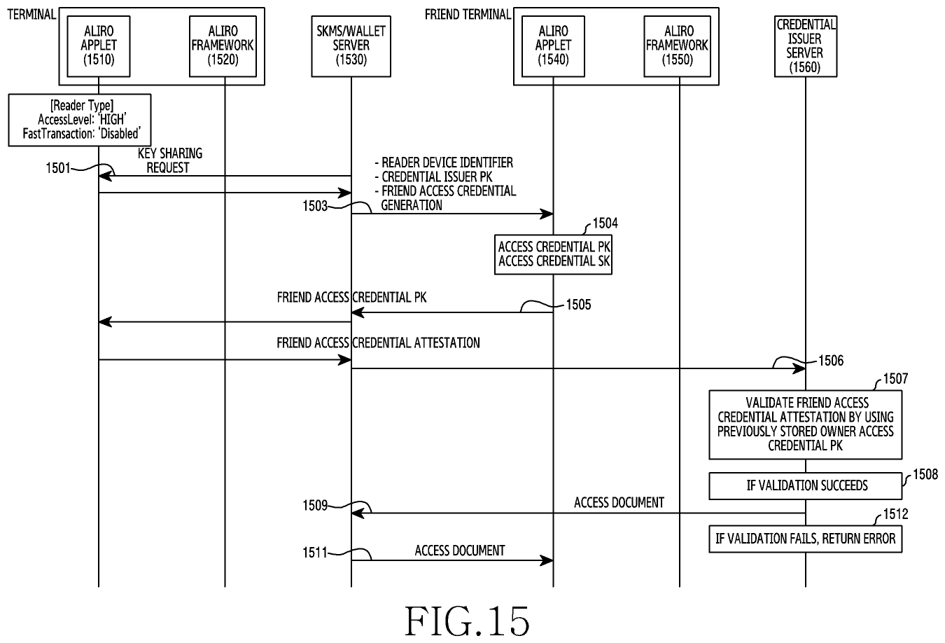

FIG. 15 illustrates signal flows in a provisioning step during a standard key sharing procedure according to an embodiment of the disclosure.

FIG. 15 may be referenced to describe signal flows between an (owner) terminal including an Aliro applet 1510 and an Aliro framework 1520, an SKMS/wallet server 1530, a friend terminal including an Aliro applet 1540 and an Aliro framework 1550, and a credential issuer server 1560. The owner terminal may already have acquired information regarding the reader device's type. In an embodiment of the disclosure, the owner terminal may have information regarding the reader device configured so as to indicate that the reader device's access level is high, and no fast transaction is supported. Alternatively, the owner terminal may have information regarding the reader device configured so as to indicate that no fast transaction is supported regardless of the reader device's access level.

In operation 1501, the SKMS/wallet server 1530 may transmit a key sharing request to the owner terminal.

In operation 1502, the owner terminal may transmit a message including the reader device's identifier, a credential issuer public key, and a request for friend access credential generation to the SKMS/wallet server 1530.

In operation 1503, the SKMS/wallet server 1530 may transmit the message received from the owner terminal in operation 1502 to the friend terminal.

In operation 1504, the friend terminal which has received a request for friend access credential generation from the owner terminal through the SKMS/wallet server 1530 may generate a key pair of an access credential PK and an access credential SK.

In operation 1505, the friend terminal may transmit the friend terminal's public key (for example, friend access credential public key) to the owner terminal through the SKMS/wallet server 1530.

In operation 1506, the owner terminal may sign the friend access credential. In addition, the owner terminal may transmit a message (for example, friend access credential attestation) including the owner terminal's signature to the credential issuer server 1560 through the SKMS/wallet server 1530.

In operation 1507, the credential issuer server 1560 may validate the friend access credential attestation by using the owner terminal's public key (for example, owner access credential PK) stored previously (for example, during the initial access of the owner terminal and the reader device). For example, the credential issuer server 1560 may detect the validity of the owner terminal's signature included in the friend access credential attestation by using the owner terminal's public key.

If the owner terminal's signature is identified valid in operation 1508, the credential issuer server 1560 may request the SKMS/wallet server 1530 to provide the friend terminal's access document in operation 1509. In operation 1511, the SKMS/wallet server 1530 may transmit the access document to the friend terminal.

If the owner terminal's signature is identified invalid in operation 1508, the credential issuer server 1560 may identify the occurrence of an error in operation 1512.

Although the SKMS/wallet server 1530 is described as a single server in the above-described steps for convenience of description, the SKMS/wallet server may exist with regard to each of the owner terminal and the friend terminal as illustrated in FIG. 4. Therefore, the SKMS/wallet server 1530 may include an SKMS/wallet server 440 regarding the owner terminal and an SKMS/wallet server 450 regarding the friend terminal.

Obviously, the above example is not limitative. Some or all of at least one operation of the provisioning in the embodiment described above may be combined or modified. Alternatively, at least one operation may be deleted, or a new procedure may be added and organically combined with the above-described operations.

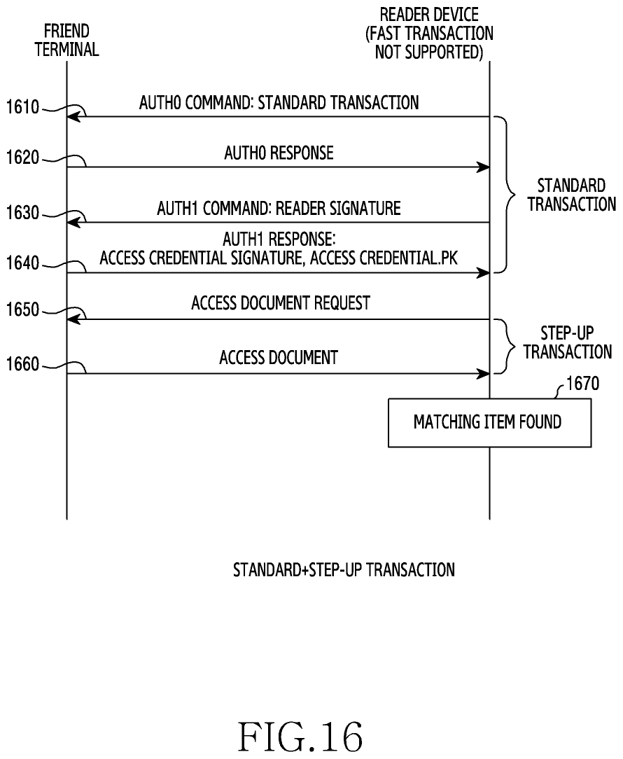

FIG. 16 illustrates signal flows in a transaction step during a standard key sharing procedure according to an embodiment of the disclosure.

Referring to FIG. 16, the owner terminal may have information regarding the reader device configured so as to indicate that the reader device's access level is high, and no fast transaction is supported. Therefore, the friend terminal may access the reader device through friend terminal authorization operations according to a standard transaction (operations 1610 to 1640 described later, which may be referred to as a standard transaction). If additional information (for example, a validation period, a period of time for which access is possible) is necessary, the reader device may further perform operations for requesting the friend terminal to provide an access document (operations 1650 to 1670 described later, which may be referred to as a step-up transaction). During the standard transaction by the friend terminal, authorization operations (for example, AUTH0 and AUTH1 ) and an access document transfer procedure may be performed identically or similarly to those during the standard transaction by the friend terminal described above with reference to FIG. 6. Therefore, descriptions overlapping those in FIG. 6 may be omitted herein.

More specifically, in operation 1610, the reader device may transmit an AUTH0 command to the friend terminal. In an embodiment of the disclosure, the authorization command may include a request for a standard transaction. In addition, the AUTH0 command may include the reader device's ephemeral public key (R.ePK)) and the reader device's identifier (R.ID).

In operation 1620, the friend terminal may transmit an AUTH0 response to the AUTH0 command in operation 1610 to the reader device.

In operation 1630, the reader device may transmit an AUTH1 command to the friend terminal. The AUTH1 command may include the reader device's signature.

In operation 1640, the friend terminal may transmit an AUTH1 response to the AUTH1 command in operation 1630 to the reader device. The AUTH1 response may include an access credential public key and an access credential signature. The friend terminal may authorize or identify the reader device through the reader device signature received from the reader device in operation 1630. In addition, the reader device may authorize or identify the friend terminal through the friend terminal's signature included in the AUTH1 response.

Through the above-described standard transaction (steps 1610 to 1640), the reader device may authorize the friend terminal which wants to gain access. However, if additional information is necessary for the friend terminal's access, the reader information may request the friend terminal to provide the necessary additional information.

In operation 1650, the reader device may transmit a request for an access document to the friend terminal.

In operation 1660, the friend terminal may transmit an access document to the reader device in response to the request for an access document from the reader device. The access document may include additional information (for example, a validation period, a period of time for which access is possible) requested by the reader device. In addition, the access document transmitted by the friend terminal may be information which the friend terminal has received and stored from the credential issuer server in the provisioning procedure (for example, FIG. 15) prior to the transaction described above. For example, the reader device may identify the period of time for which access is possible by the friend terminal authorized through the standard transaction (operations 1610 to 1640) described above, based on information included in the access document.

The above-described step-up transaction (operations 1660 to 1670) may be a procedure which may be performed as needed by the reader device, unlike the above-described standard transaction (operations 1610 to 1640) by the friend terminal. Therefore, the access document request and response procedures may be omitted.

In operation 1670, the reader device may allow the friend terminal to access if the friend terminal's Kpersistent matches with the Kpersistent stored therein. For example, since no fast transaction is supported, the reader device may not determine whether or not to allow the friend terminal to access through a cryptogram, but may determine whether or not to allow the friend terminal to access, based on the friend terminal's public key stored in the access document (for example, operation 1660).

Obviously, the above example is not limitative. Some or all of at least one operation of the transaction in the embodiment described above may be combined or modified. Alternatively, at least one operation may be deleted, or a new procedure may be added and organically combined with the above-described operations.

FIG. 17 illustrates signal flows in a provisioning step during a medium key sharing procedure according to an embodiment of the disclosure.

FIG. 17 may be referenced to describe signal flows between an (owner) terminal including an Aliro applet 1710 and an Aliro framework 1720, an SKMS/wallet server 1730, a friend terminal including an Aliro applet 1740 and an Aliro framework 1750, and a credential issuer server 1760. The owner terminal may already have acquired information regarding the reader device's type. In an embodiment of the disclosure, the owner terminal may have information regarding the reader device configured so as to indicate that the reader device's access level is medium, and a fast transaction is supported.

In operation 1701, the SKMS/wallet server 1730 may transmit a medium key sharing request to the owner terminal.

In operation 1702, the owner terminal may generate a cryptogram encrypted through the reader device's public key.

In operation 1703, the owner terminal may transmit a message including the cryptogram generated in operation 1702, the reader device's identifier, a credential issuer public key, and a request for friend access credential generation to the SKMS/wallet server 1730.

In operation 1704, the SKMS/wallet server 1730 may transmit the message received from the owner terminal in operation 1703 to the friend terminal.

In operation 1705, the friend terminal which has received a request for friend access credential generation from the owner terminal through the SKMS/wallet server 1730 may generate a key pair of an access credential PK and an access credential SK. The generated key pair may be intended to generate the same cryptogram as the owner terminal's cryptogram received in operation 1703.

In operation 1706, the friend terminal may transmit the friend terminal's public key (for example, friend access credential public key) to the owner terminal through the SKMS/wallet server 1730.

In operation 1707, the owner terminal may sign the friend access credential. In addition, the owner terminal may transmit a message (for example, friend access credential attestation) including the owner terminal's signature to the credential issuer server 1760 through the SKMS/wallet server 1730.

In operation 1708, the credential issuer server 1760 may validate the friend access credential attestation by using the owner terminal's public key (for example, owner access credential PK) stored previously (for example, during the initial access of the owner terminal and the reader device). For example, the credential issuer server 1760 may detect the validity of the owner terminal's signature included in the friend access credential attestation by using the owner terminal's public key.

If the owner terminal's signature is identified valid in operation 1709, the credential issuer server 1760 may request the SKMS/wallet server 1730 to provide the friend terminal's access document in operation 1711. In operation 1712, the SKMS/wallet server 1730 may notify the owner terminal of successful validation of the friend terminal. In operation 1713, the SKMS/wallet server 1730 may transmit the access document to the friend terminal.

If the owner terminal's signature is identified invalid in operation 1708, the credential issuer server 1760 may identify the occurrence of an error in operation 1714.

Although the SKMS/wallet server 1730 is described as a single server in the above-described steps for convenience of description, the SKMS/wallet server may exist with regard to each of the owner terminal and the friend terminal as illustrated in FIG. 4. Therefore, the SKMS/wallet server 1730 may include an SKMS/wallet server 440 regarding the owner terminal and an SKMS/wallet server 450 regarding the friend terminal.

Obviously, the above example is not limitative. Some or all of at least one operation of the provisioning in the embodiment described above may be combined or modified. Alternatively, at least one operation may be deleted, or a new procedure may be added and organically combined with the above-described operations.

FIG. 18 illustrates signal flows in a transaction step during a medium key sharing procedure according to an embodiment of the disclosure.

Referring to FIG. 18, the owner terminal may have information regarding the reader device configured so as to indicate that the reader device's access level is medium, and a fast transaction is supported. Therefore, the friend terminal may access the reader device through friend terminal authorization operations according to a medium transaction (operations 1810 to 1840 described later, which may be referred to as a fast transaction). If additional information (for example, a validation period, a period of time for which access is possible) is necessary, the reader device may further perform operations for requesting the friend terminal to provide an access document (operations 1850 to 1870 described later, which may be referred to as a step-up transaction). During the fast transaction by the friend terminal, an authorization operation (for example, AUTH0) and an access document transfer procedure may be performed identically or similarly to those during the fast transaction by the friend terminal described above with reference to FIG. 7. Therefore, descriptions overlapping those in FIG. 7 may be omitted herein.

More specifically, in operation 1810, the reader device may transmit an AUTH0 command to the friend terminal. In an embodiment of the disclosure, the AUTH0 command may include a request for a fast transaction. In addition, the AUTH0 command may include at least one of the reader device's ephemeral public key (R.ePK)) or the reader device's identifier (R.ID).

In operation 1820, the friend terminal may transmit an AUTH0 response to the AUTH0 command in operation 1810 to the reader device. The AUTH0 response may include the friend terminal's ID and a cryptogram. The cryptogram included in the AUTH0 response may be identical to the cryptogram generated by the owner terminal.

In operation 1830, if the reader device cannot find the ID received from the friend terminal among terminal IDs stored therein, the reader device may identify the received ID as the friend terminal's ID, and may decrypt the cryptogram through the reader device's private key. Alternatively, if the reader device can find the ID received from the friend terminal among terminal IDs stored therein, the reader device may identify the received ID as the owner terminal's ID, and may decrypt the cryptogram through the owner terminal's private key (CryptogramSK). The reader device may identify whether the friend terminal's Kpersistent matches with the Kpersistent stored therein.

Through the above-described fast transaction (operations 1810 to 1820), the reader device may authorize the friend terminal which wants to gain access. However, if additional information is necessary for the friend terminal's access, the reader device may request the friend terminal to provide the necessary additional information.

In operation 1840, the reader device may transmit a request for an access document to the friend terminal.

In operation 1850, the friend terminal may transmit an access document to the reader device in response to the request for an access document from the reader device. The access document may include additional information (for example, a validation period, a period of time for which access is possible) requested by the reader device. In addition, the access document transmitted by the friend terminal may be information which the friend terminal has received and stored from the credential issuer server in the provisioning procedure (for example, FIG. 17) prior to the transaction described above. For example, the reader device may identify the period of time for which access is possible by the friend terminal authorized through the fast transaction (operations 1810 to 1820) described above, based on information included in the access document.

The above-described step-up transaction (operations 1840 to 1850) may be a procedure which may be performed as needed by the reader device, unlike the above-described fast transaction (operations 1810 to 1820) by the friend terminal. Therefore, the access document request and response procedures may be omitted.

Obviously, the above example is not limitative. Some or all of at least one operation of the transaction in the embodiment described above may be combined or modified. Alternatively, at least one operation may be deleted, or a new procedure may be added and organically combined with the above-described operations.

FIG. 19 illustrates signal flows in a provisioning step during a fast key sharing procedure according to an embodiment of the disclosure.

FIG. 19 may be referenced to describe signal flows between an (owner) terminal including an Aliro applet 1910 and an Aliro framework 1920, an SKMS/wallet server 1930, a friend terminal including an Aliro applet 1940 and an Aliro framework 1950, and a credential issuer server 1960. The owner terminal may already have acquired information regarding the reader device's type. In an embodiment of the disclosure, the owner terminal may have information regarding the reader device configured so as to indicate that the reader device's access level is low, and a fast transaction is supported.

In operation 1901, the SKMS/wallet server 1930 may transmit a fast key sharing request to the owner terminal.

In operation 1902, the owner terminal may generate a cryptogram encrypted through the reader device's public key.

In operation 1903, the owner terminal may transmit a message including the reader device's identifier and the cryptogram generated in operation 1902 to the SKMS/wallet server 1930.

In operation 1904, the SKMS/wallet server 1930 may transmit the message received from the owner terminal in operation 1903 to the friend terminal.

In operation 1905, the friend terminal may transmit an acknowledge (ACK) regarding message reception in operation 1904 to the owner terminal through the SKMS/wallet server 1930.

Although the SKMS/wallet server 1930 is described as a single server in the above-described steps for convenience of description, the SKMS/wallet server may exist with regard to each of the owner terminal and the friend terminal as illustrated in FIG. 4. Therefore, the SKMS/wallet server 1930 may include an SKMS/wallet server 440 regarding the owner terminal and an SKMS/wallet server 450 regarding the friend terminal.

Obviously, the above example is not limitative. Some or all of at least one operation of the provisioning in the embodiment described above may be combined or modified. Alternatively, at least one operation may be deleted, or a new procedure may be added and organically combined with the above-described operations.

FIG. 20 illustrates signal flows in a transaction step during a fast key sharing procedure according to an embodiment of the disclosure.

Referring to FIG. 20, the owner terminal may have information regarding the reader device configured so as to indicate that the reader device's access level is fast, and a fast transaction is supported. Therefore, the friend terminal may access the reader device through friend terminal authorization operations according to a fast transaction (operations 2010 to 2020 described later, which may be referred to as a fast transaction). During the fast transaction by the friend terminal, an authorization operation (for example, AUTH0) may be performed identically or similarly to that during the fast transaction by the friend terminal described above with reference to FIG. 7. Therefore, descriptions overlapping those in FIG. 7 may be omitted herein.

More specifically, in operation 2010, the reader device may transmit an AUTH0 command to the friend terminal. In an embodiment of the disclosure, the AUTH0 command may include a request for a fast transaction. In addition, the AUTH0 command may include at least one of the reader device's ephemeral public key (R.ePK)) or the reader device's identifier (R.ID).

In operation 2020, the friend terminal may transmit an AUTH0 response to the AUTH0 command in operation 2010 to the reader device. The AUTH0 response may include the friend terminal's ID and a cryptogram generated by the owner terminal.

In operation 2030, if the reader device cannot find the ID received from the friend terminal among terminal IDs stored therein, the reader device may identify the received ID as the friend terminal's ID, and may decrypt the cryptogram through the reader device's private key. Alternatively, if the reader device can find the ID received from the friend terminal among terminal IDs stored therein, the reader device may identify the received ID as the owner terminal's ID, and may decrypt the cryptogram through the owner terminal's private key (CryptogramSK). The reader device may identify that the decrypted cryptogram is valid if the friend terminal's Kpersistent matches with the Kpersistent stored therein, thereby allowing the friend terminal to access.

Through the above-described fast transaction (operations 2010 to 2020), the reader device may authorize the friend terminal which wants to gain access. However, unlike the medium key sharing procedure (for example, FIGS. 17 and 18), the reader device may allow the friend terminal to access without other additional information (for example, access document), based on the owner terminal's cryptogram, in the fast key sharing procedure. Accordingly, the friend terminal may access the reader device more quickly, and signaling overhead due to the additional authorization procedure and the access document request may be reduced.

Obviously, the above example is not limitative. Some or all of at least one operation of the transaction in the embodiment described above may be combined or modified. Alternatively, at least one operation may be deleted, or a new procedure may be added and organically combined with the above-described operations.

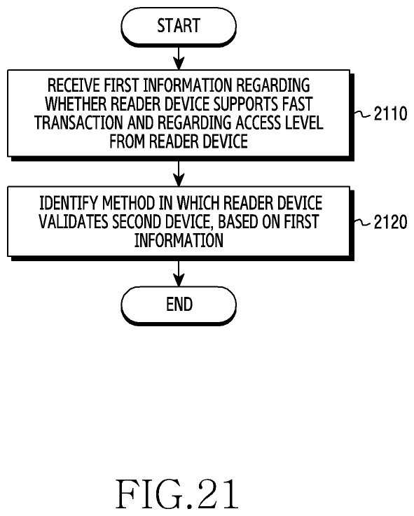

FIG. 21 illustrates the order of operations of an owner terminal according to an embodiment of the disclosure.

FIG. 21 illustrates the order of operations for determining a key sharing type, based on information regarding a reader device, which the owner terminal has received from the reader device (for example, information regarding whether the reader device supports a fast transaction and regarding the reader device's access level), according to an embodiment of the disclosure. The following embodiment of the disclosure may be based on above descriptions made with reference to FIGS. 6 to 20.

In operation 2110, first information regarding whether the reader device supports a fast transaction and regarding the reader device's access level may be received from the reader device.

In operation 2120, a first device may identify a method in which the reader device validates a second device, based on the first information.

The first device may refer to an owner terminal validated by the reader device, and the second device may refer to a friend terminal not validated by the reader device.

Obviously, the above example is not limitative. Some or all of at least one operation of the first device in the embodiment described above may be combined or modified. Alternatively, at least one operation may be deleted, or a new procedure may be added and organically combined with the above-described operations.

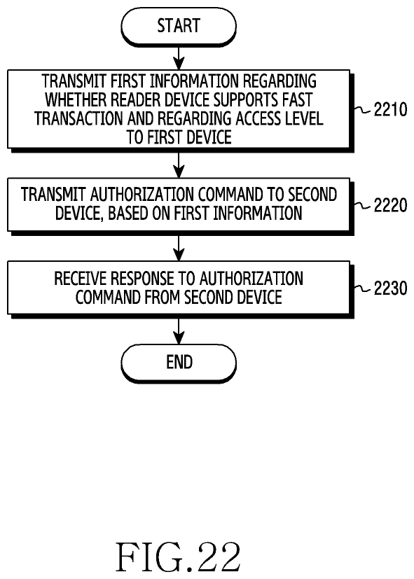

FIG. 22 illustrates the order of operations of a reader device according to an embodiment of the disclosure.

FIG. 22 illustrates the order of operations of a reader device according to a key sharing type determined based on information regarding the reader device (for example, information regarding whether the reader device supports a fast transaction and regarding the reader device's access level), according to an embodiment of the disclosure. The following embodiment of the disclosure may be based on above descriptions made with reference to FIGS. 6 to 20.

In operation 2210, the reader device may transmit first information regarding whether the reader device supports a fast transaction and regarding the reader device's access level to a first device.

In operation 2220, the reader device may transmit an authorization command to a second device, based on the first information.

In operation 2230, the reader device may receive a response to the authorization command from the second device.

The response may include second information including a device identifier and a cryptogram. The method in which the reader device validates the second device may be based on the first information. The first device may refer to an owner terminal validated by the reader device, and the second device may refer to a friend terminal not validated by the reader device.

Obviously, the above example is not limitative. Some or all of at least one operation of the reader device in the embodiment described above may be combined or modified. Alternatively, at least one operation may be deleted, or a new procedure may be added and organically combined with the above-described operations.

A method performed by a first device in a wireless communication system according to an embodiment of the disclosure may include a step of receiving, from a reader device, first information regarding whether the reader device supports a fast transaction and regarding the reader device's access level, and a step of identifying a method in which the reader device validates a second device, based on the first information. The first device may be an owner device validated by the reader device, and the second device may be a friend device not validated by the reader device.

In an embodiment of the disclosure, the method may further include a step of transmitting second information including the first device's cryptogram and the reader device's identifier to the second device in case that the fast transaction is supported.

In an embodiment of the disclosure, validation of the second device's access credential may be based on the cryptogram, and whether or not to validate the access credential may be based on the access level of the reader device.

In an embodiment of the disclosure, decryption of the cryptogram may be based on the second device's identifier.

In an embodiment of the disclosure, the step of receiving the first information may further include a step of receiving an authorization command regarding the first device from the reader device, and the first information may be included in the authorization command or the reader device's update request regarding the first device's access information.

A method performed by a reader device in a wireless communication system according to an embodiment of the disclosure may include a step of transmitting, to a first device, first information regarding whether the reader device supports a fast transaction and regarding the reader device's access level, a step of transmitting an authorization command to a second device, based on the first information, and a step of receiving a response to the authorization command from the second device. The response may include second information including a cryptogram and an identifier of a device, a method in which the reader device validates the second device may be based on the first information, the first device may be an owner device validated by the reader device, and the second device may be a friend device not validated by the reader device.

In an embodiment of the disclosure, in case that the fast transaction is supported, the cryptogram may be the first device's cryptogram.

In an embodiment of the disclosure, validation of the second device's access credential may be based on the cryptogram, and whether or not to validate the access credential may be based on the access level of the reader device.

In an embodiment of the disclosure, the method may further include a step of, in case that the identifier is not stored in the reader device, identifying the identifier as the second device's identifier, and a step of decrypting the cryptogram, based on the reader device's private key.

In an embodiment of the disclosure, the step of transmitting the first information may further include a step of transmitting an authorization command regarding the first device to the first device, and the first information may be included in the authorization command or the reader device's update request regarding the first device's access information.

A first device in a wireless communication system according to an embodiment of the disclosure may include a transceiver and at least one processor coupled to the transceiver. The at least one processor may be configured to receive, from a reader device, first information regarding whether the reader device supports a fast transaction and regarding the reader device's access level, and identify a method in which the reader device validates a second device, based on the first information. The first device may be an owner device validated by the reader device, and the second device may be a friend device not validated by the reader device.

In an embodiment of the disclosure, the at least one processor may be further configured to transmit second information including the first device's cryptogram and the reader device's identifier to the second device in case that the fast transaction is supported.

In an embodiment of the disclosure, validation of the second device's access credential may be based on the cryptogram, and whether or not to validate the access credential may be based on the access level of the reader device.

In an embodiment of the disclosure, decryption of the cryptogram may be based on the second device's identifier.

In an embodiment of the disclosure, the at least one processor may be further configured to receive an authorization command regarding the first device from the reader device, and the first information may be included in the authorization command or the reader device's update request regarding the first device's access information.

A reader device in a wireless communication system according to an embodiment of the disclosure may be configured to transmit, to a first device, first information regarding whether the reader device supports a fast transaction and regarding the reader device's access level, transmit an authorization command to a second device, based on the first information, and receive a response to the authorization command from the second device. The response may include second information including a cryptogram and an identifier of a device, a method in which the reader device validates the second device may be based on the first information, the first device may be an owner device validated by the reader device, and the second device may be a friend device not validated by the reader device.

In an embodiment of the disclosure, in case that the fast transaction is supported, the cryptogram may be the first device's cryptogram.

In an embodiment of the disclosure, validation of the second device's access credential may be based on the cryptogram, and whether or not to validate the access credential may be based on the access level of the reader device.

In an embodiment of the disclosure, the at least one processor may be further configured to, in case that the identifier is not stored in the reader device, identify the identifier as the second device's identifier, and decrypt the cryptogram, based on the reader device's private key.

In an embodiment of the disclosure, the at least one processor may be further configured to transmit an authorization command regarding the first device to the first device, and the first information may be included in the authorization command or the reader device's update request regarding the first device's access information.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks, such as the Internet, Intranet, local area network (LAN), wide LAN (WLAN), and storage area network (SAN) or a combination thereof. Such a storage device may access the electronic device via an external port. In addition, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first device in a wireless communication system, the method comprising:
receiving, from a reader device, first information on whether the reader device supports a fast transaction and the reader device's access level; and
identifying a method in which the reader device validates a second device, based on the first information,
wherein the first device is an owner device validated by the reader device, and
wherein the second device is a friend device not validated by the reader device.

2. The method of claim 1, further comprising:
transmitting, to the second device, second information comprising the first device's cryptogram and the reader device's identifier in case that the fast transaction is supported.

3. The method of claim 2,
wherein validation of the second device's access credential is based on the cryptogram, and
wherein whether to perform the validation for the access credential is based on the access level of the reader device.

4. The method of claim 2, wherein decryption of the cryptogram is based on the second device's identifier.

5. The method of claim 1,
wherein the receiving of the first information further comprises:
receiving, from the reader device, an authorization command regarding the first device, and
wherein the first information is included in the authorization command or the reader device's update request for the first device's access information.

6. A method performed by a reader device in a wireless communication system, the method comprising:
transmitting, to a first device, first information on whether the reader device supports a fast transaction and the reader device's access level;
transmitting, to a second device, an authorization command, based on the first information; and
receiving, from the second device, a response to the authorization command,
wherein the response includes second information including a cryptogram and an identifier of a device,
wherein a method in which the reader device validates the second device is based on the first information,
wherein the first device is an owner device validated by the reader device, and
wherein the second device is a friend device not validated by the reader device.

7. The method of claim 6, wherein, in case that the fast transaction is supported, the cryptogram is the first device's cryptogram.

8. The method of claim 6,
wherein validation of the second device's access credential is based on the cryptogram, and
wherein whether to perform the validation for the access credential is based on the access level of the reader device.

9. The method of claim 6, further comprising:
in case that the identifier is not stored in the reader device, identifying the identifier as the second device's identifier; and
decrypting the cryptogram, based on the reader device's private key.

10. The method of claim 6,
wherein the transmitting of the first information further comprises:
transmitting, to the first device, an authorization command regarding the first device, and
wherein the first information is included in the authorization command or the reader device's update request for the first device's access information.

11. A first device in a wireless communication system, the first device comprising:
a transceiver; and
at least one processor coupled with the transceiver and configured to:
receive, from a reader device, first information on whether the reader device supports a fast transaction and the reader device's access level, and
identify a method in which the reader device validates a second device, based on the first information,
wherein the first device is an owner device validated by the reader device, and
wherein the second device is a friend device not validated by the reader device.

12. The first device of claim 11, wherein the at least one processor is further configured to:
transmit, to the second device, second information comprising the first device's cryptogram and the reader device's identifier in case that the fast transaction is supported.

13. The first device of claim 12,
wherein validation of the second device's access credential is based on the cryptogram, and
wherein whether to perform the validation for the access credential is based on the access level of the reader device.

14. The first device of claim 12, wherein decryption of the cryptogram is based on the second device's identifier.

15. The first device of claim 11,
wherein the at least one processor is further configured to:
receive, from the reader device, an authorization command regarding the first device, and
wherein the first information is included in the authorization command or the reader device's update request for the first device's access information.

16. A reader device in a wireless communication system, the reader device comprising:
a transceiver; and
at least one processor coupled with the transceiver and configured to:
transmit, to a first device, first information on whether the reader device supports a fast transaction and the reader device's access level,
transmit, to a second device, an authorization command, based on the first information, and
receive, from the second device, a response to the authorization command,
wherein the response includes second information including a cryptogram and an identifier of a device,
wherein a method in which the reader device validates the second device is based on the first information,
wherein the first device is an owner device validated by the reader device, and
wherein the second device is a friend device not validated by the reader device.

17. The reader device of claim 16, wherein, in case that the fast transaction is supported, the cryptogram is the first device's cryptogram.

18. The reader device of claim 16,
wherein validation of the second device's access credential is based on the cryptogram, and
wherein whether to perform the validation for the access credential is based on the access level of the reader device.

19. The reader device of claim 16, wherein the at least one processor is further configured to:
in case that the identifier is not stored in the reader device, identify the identifier as the second device's identifier, and
decrypt the cryptogram, based on the reader device's private key.

20. The reader device of claim 16, wherein the at least one processor is further configured to:
transmit, to the first device, an authorization command regarding the first device, and
wherein the first information is included in the authorization command or the reader device's update request for the first device's access information.
